(19) United States
(12) Patent Application Publication
(10) Pub. No.: US 2026/0254727 A1
(43) Pub. Date: Aug. 27, 2026

(54) METHODS AND APPARATUSES FOR AVOIDING A PERFORMANCE DEGRADATION IN A NETWORK

(71) Applicant: Telefonaktiebolaget LM Ericsson (publ), Stockholm (SE)

(72) Inventors: Sabrine AROUA, Antony (FR); Mathieu LECONTE, Verrières-le-Buisson (FR); Abdulrahman ALABBASI, Kista (SE); Athanasios KARAPANTELAKIS, Solna (SE); Danesh DAROUI, Gothenburg (SE); Lackis ELEFTHERIADIS, Valbo (SE); Marin ORLIC, Bromma (SE); Oleg GORBATOV, Luleå (SE)

(21) Appl. No.: 19/160,179

(22) PCT Filed: Sep. 5, 2023
(86) PCT No.: PCT/EP2023/074301

§ 371 Date: Aug. 27, 2025

(30) Foreign Application Priority Data
Mar. 3, 2023 (GR) 20230100184

(51) Int. Cl. H04L 41/147; G06N 3/092; H04L 41/0894; H04L 41/16

(52) U.S. Cl. CPC H04L 41/147; G06N 3/092; H04L 41/0894; H04L 41/16

(57) ABSTRACT

Methods and apparatuses for improving a performance of a network. A method in a first network function comprises obtaining, at an initial time to, a prediction of a performance degradation associated with at least one performance metric at a first time, t₀+T, in the future; and responsive to obtaining the prediction, at each current time, t, from t₀ to t₀+T: selecting a first set of network functions, NFs, fᵢ, wherein each network function in the first set is associated with a delay time, d(x_{i,t}) for the NF to impact the network, wherein for each of the first set of NFs a first condition of d(x_{i,t})<t₀+T−t is met; and transmitting an indication of the prediction to the first set of NFs.

### TECHNICAL FIELD

Embodiments described herein relate to methods and apparatuses for avoiding a predicted degradation in one or more performance metrics in a network. In particular, embodiments described herein proactively inform one or more network functions of a predicted degradation in one or more performance metrics in the network.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Mobile networks are becoming more and more heterogeneous and complex. In these complex networks, a huge quantity of data is exchanged between the different components in the network. Data collection and processing to produce useful information is challenging in such a complex system. As a result, in 5G, a fundamental unit known as Network Data Analytics Function, NWDAF exists.

A Network Data Analytics Function (NWDAF) is a 3GPP network function in the 5G Core Networks 3GPP TS 23.288 v 18.0.0.

The NWDAF is designed to collect data from diverse data sources such as User Equipments (UE), Network Functions (NF), and the Operation, Administration and Maintenance (OAM) located in the 5G Core, Cloud, and Edge networks. The NWDAF can generate different analytic reports (statistics/predictions) about the past and future of the network's states. The NWDAF may then provide analytic reports to 5G Core NFs to advise them about the changes in the network's behavior and eventual events that may happen. Therefore, once an NF receives an analytic report, it may interact with its environment through a specific action in the pursuit of a goal.

The NWDAF can generate different analytic reports to provide each NF with information that it has requested. The NFs may also be referred to as service consumers since they benefit from the NWDAF's services, such as Slice load level-related network data analytics, UE-related analytics, and user data congestion analytics. Generally, an NF subscribes to NWDAF to receive predictions on the part of the network's state they are interested in. For example, an NF may subscribe to NWDAF to receive: an event-based, periodic, threshold, or (on-demand) one-time notification. In the one-time subscription, it will be appreciated that the NF may be automatically unsubscribed once it receives an analytic report from NWDAF.

Once one NF receives the requested analytic report(s), the NF may decide whether to interact with the surrounding environment, and if so how to interact in order to improve one or more Key Performance Indicators (KPIs) such as delay and traffic throughput. In current existing systems, the NFs' actions are not revealed to NWDAF.

An action performed by an NF may be considered as the mechanism one NF can make to produce a transition from one network state to another network state. A network state may comprise the values of one or more KPIs of the network at a particular time.

The current NWDAF's interaction with NFs is limited to responding to the NFs' requests with analytics reports. The way one NF reacts to its surrounding environment (e.g. the actions taken by an NF) is not revealed to the NWDAF. Thus, the current NWDAF has limited capabilities to manage and recommend how the NFs should interact with the network. It may be beneficial to empower the NWDAF with novel functionalities to achieve better user experience and network management.

The NWDAF has a global view of what might happen in the network. For example, the NWDAF may be capable of deciding when an action of a particular NF is needed. The NWDAF may be able to understand the need of every NFs in terms of analytics reports based on its previous requests. Moreover, the NWDAF may observe and learn the performance metrics that each NF may impact. As a result, the NWDAF may be employed to provide robust coordination functionalities. Different NFs might affect non-empty disjoint sets of performance metrics, e.g., delay. For example, one NF, i.e., NF1, may manage the physical resource blocks which can have impacts on the traffic delay. Another NF, e.g. NF2, may be responsible for traffic scheduling, which may also affect delay. Consequently, it would be beneficial for the NWDAF to be able to coordinate NF1 and NF2 to realize better network performance.

The delay of the impact of an NFs' interaction with the network may be understood as the time required by the NF to transition the network's state (which may comprise a set of performance metrics) to a new network state, once it has received an analytic report from the NWDAF.

FIG. 1 is a graph illustrating the delay of the impact for an NF, e.g. NF1.

In the graph 100, a NF1 receives an analytic report at time t1. NF1 then makes an action at time t2. However, the overall impact on the performance metrics does not occur until time t3. The difference between t3 and t1 may be referred to as the delay of the impact of the first NF.

The length of the delay of impact may depend on the NF, its policy, and/or some other parameters that are not revealed to the NWDAF.

The delay of the impact represents an essential and smart metric to understand when relevant NFs should be involved to interact with the networks.

Most existing solutions focus on the analysis and design of relevant metrics that can be exploited to improve network performance. Almost all current studies utilize the correlation between the requested analytic reports to learn the correlation between NFs' interaction and thereby understand how a set of NFs might impact the same performance metrics (e.g. KPIs). After that, correlated NWDAF NFs may be invited to collaborate.

### SUMMARY

According to some embodiments there is provided a computer-implemented method in a first network function, NF, for improving a performance of a network. The method comprising obtaining, at an initial time to, a prediction of a performance degradation associated with at least one performance metric at a first time, t₀+T, in the future; and responsive to obtaining the prediction, at each current time, t, from t₀ to t₀+T: selecting a first set of network functions, NFs, fᵢ, wherein each network function in the first set is associated with a delay time, d(x_{i,t}) for the NF to impact the network, wherein for each of the first set of NFs a first condition of d(x_{i,t})<t₀+T−t is met; and transmitting an indication of the prediction to the first set of NFs.

According to some embodiments there is provided a method in a second network function for avoiding a degradation in performance of one or more performance metrics in a network. The method comprises transmitting, to an analytics network function, an indication that the second network function will accept being notified proactively with an analytic report.

According to some embodiments there is provided a first network function for improving a performance of a network. The first network function comprises processing circuitry configured to cause the first network function to: obtain, at an initial time to, a prediction of a performance degradation associated with at least one performance metric at a first time, t₀+T, in the future; and responsive to obtaining the prediction, at each current time, t, from t₀ to t₀+T: select a first set of network functions, NFs, fᵢ, wherein each network function in the first set is associated with a delay time, d(x_{i,t}) for the NF to impact the network, wherein for each of the first set of NFs a first condition of d(x_{i,t})<t₀+T−t is met; and transmit an indication of the prediction to the first set of NFs.

According to some embodiments there is provided a second network function for avoiding a degradation in performance of one or more performance metrics in a network. The second network function comprising processing circuitry configured to cause the second network function to: transmit, to an analytics network function, an indication that the second network function will accept being notified proactively with an analytic report.

Aspects and examples of the present disclosure thus provide methods and apparatuses for that can avoid degradation in performance of one or more performance metrics in a network.

For the purposes of the present disclosure, the term “Machine Learning, ML, model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task. References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a graph illustrating the delay of the impact for an NF;

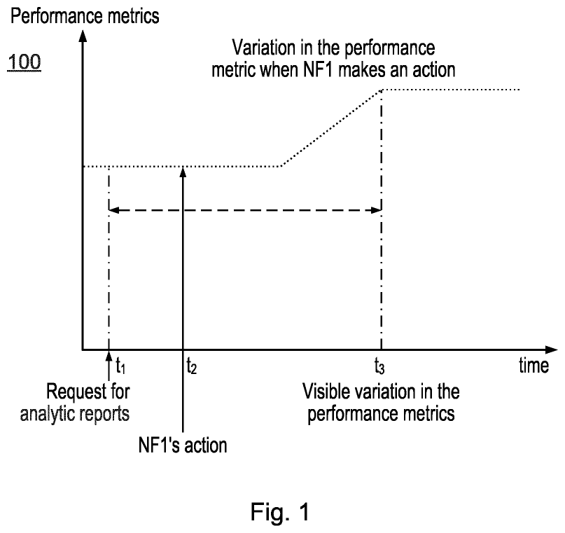

FIG. 2 illustrates an example of a delay performance metric, and how it may be altered by a NF in a network;

FIG. 3 depicts how the predicted delay degradation is avoided when NWDAF proactively contacts NF2 to interact with the network according to some embodiments;

FIG. 4 illustrates a computer-implemented method in a first network function, NF, for improving a performance of a network;

FIG. 5 illustrates an example of how step 402 may be performed utilising a ML model, in particular a reinforcement learning (RL) model;

FIG. 6 illustrates an example RL model 600 according to some embodiments;

FIG. 7 illustrates a method in a second network function for avoiding degradation of performance of one or more performance metrics in a network;

FIG. 8 is a signaling diagram illustrating an example implementation of the methods of FIGS. 4 to 7;

FIG. 9 illustrates an example in which network state transitions to a new network state due to the interaction of just one NF;

FIG. 10 illustrates how the performance metrics may change when there is an overlap between two or more NFs' interactions with the environment;

FIG. 11 illustrates a computer-implemented method for learning a delay of impact of one or more network functions' interactions with a network;

FIG. 12 is a signalling diagram illustrating how a NF subscribes to receive analytic reports;

FIG. 13 illustrates an example of the ML model;

FIG. 14 illustrates a computer-implemented method for transmitting analytic reports to one or more NFs in a network;

FIG. 15 illustrates a method, in a second network function, for utilising analytic reports;

FIG. 16 is a signalling diagram illustrating an example implementation of the methods of FIGS. 14 and 15;

FIG. 17 illustrates an example of the inputs and outputs of the ML model according to some embodiments;

FIG. 18 illustrates a network function comprising processing circuitry (or logic)

FIG. 19 is a block diagram illustrating a first network function according to some embodiments;

FIG. 20 is a block diagram illustrating a second network function according to some embodiments;

FIG. 21 illustrates how the embodiments described herein may be used to avoid the degradation of the performance metrics.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

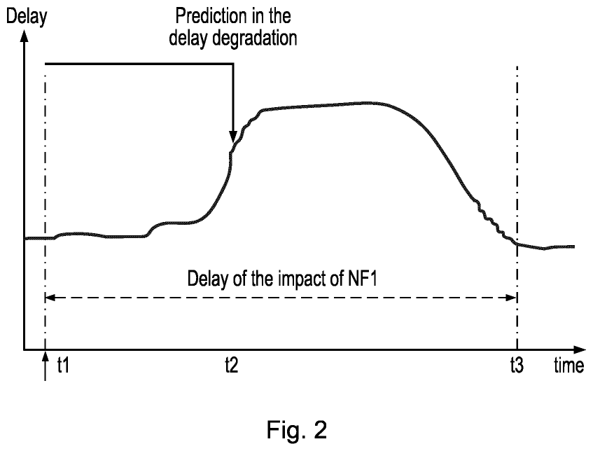

FIG. 2 illustrates an example of a delay performance metric, and how it may be altered by a NF in a network.

In this example, NF1 requests an analytic report from the NWDAF at a time t1. The NWDAF sends the requested analytic report, which indicates a predicted increase in delay at a time t2. However, the delay of impact of NF1 may mean that NF1 will not be able to decrease the delay until time t3. There is therefore a degradation in the delay between the times t2 and t3.

It will be appreciated that, if there is another NF in the network (e.g. NF2) that may be able to improve the delay before the time t3, then it may be more efficient to enable the NWDAF to proactively contact NF2 to ask NF2 to interact with the network and avoid the degradation in the delay that would otherwise occur between t2 and t3.

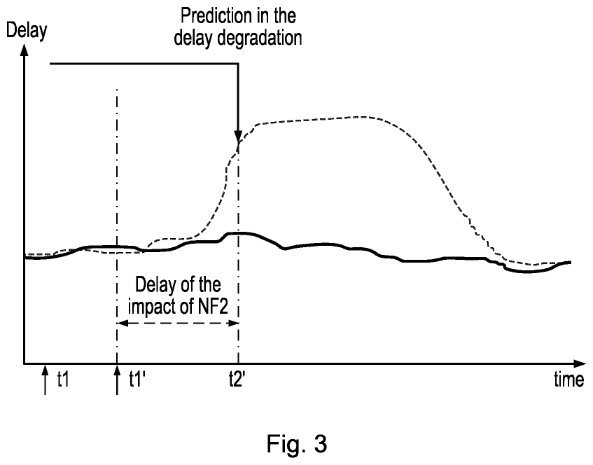

FIG. 3 depicts how the predicted delay degradation is avoided when NWDAF proactively contacts NF2 to interact with the network according to some embodiments. In this example, the NWDAF is contacted by NF1 at time t1, as described in FIG. 2. However, the NWDAF may be aware that the delay of impact of NF1 is going to mean that any action taken by NF1 will be too slow to prevent any degradation in the delay performance metric.

So, at time t1′ the NWDAF proactively contacts NF2. The NWDAF may be aware that the delay of impact of NF2 is short enough (e.g. by t2′) to be able to prevent any degradation in the delay performance metric. Therefore, by contacting NF2 at t1′, the action of NF2 may prevent any degradation in the delay performance metric.

Embodiments described herein therefore provide methods and apparatuses for proactive control of the performance metrics by considering the NFs' delay of impact. The number of existing NFs might be high. Therefore, the NWDAF according to embodiments described herein may be responsible for selecting relevant NFs that will interact with the network to improve the performance metrics before a predicted degradation. The NWDAF may then proactively transmit analytics reports to the selected NFs in order to incite their interaction with the network.

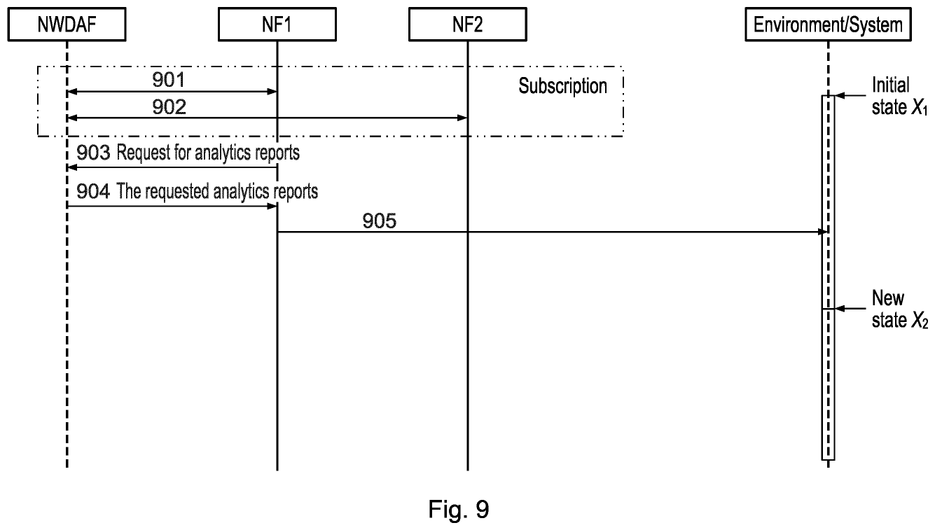

In FIGS. 9 to 17 below, the concept of the delay of impact is introduced, and a machine learning model is proposed to determine the delay of the impact of every NF based on the received analytic reports and the variation in the performance metrics. It will be appreciated that the NWDAF may learn or be made of the delay of the impact in other ways.

Embodiments described herein introduce Proactive Control of the network performances based on the Network Functions' Delay of the Impact, which may be referred to herein as “PC-NFDI.” PC-NFDI may comprise utilising a ML model, for example Reinforcement Learning (RL). PC-NFDI may exploit the delay of the impact of the existing NFs and enable the NWDAF to select relevant NFs suitable to improve the network performance and to proactively send them analytics reports to avoid a predicted performance degradation. NWDAF proceeds with this proactive interaction with NFs when degradation in the performance metric is detected, and none of the current NFs asking for analytics reports and capable of avoiding this degradation is taking some action. Many NFs might be present in the network, and they may be able to affect disjoint sets of KPIs.

Once the NWDAF predicts a future performance degradation, it may start executing PC-NFDI, which may be equipped with at least functionalities:
A selection of a set of NFs based on the delay of the impact:
A Proactive transmission of analytics reports to the selected set of NFs.

One objective of the PC-NFDI may be to enable NWDAF to select relevant NFs that can adjust and improve KPIs once it predicts future degradation. Relevant Network Functions (NFs) may be chosen based on their delay of the impact. Accordingly, they may be able to affect the network before the predicted degradation occurs.

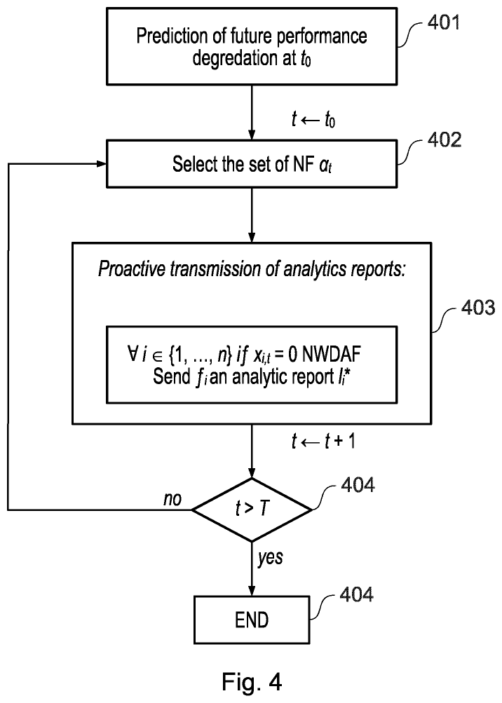

FIG. 4 illustrates a computer-implemented method in a first network function, NF, for improving a performance of a network.

The method 400 may be performed by a network node, which may comprise a physical or virtual node, and may be implemented in a computing device or server apparatus and/or in a virtualized environment, for example in a cloud, edge cloud or fog deployment. In particular, the method 400 may be performed by an analytics network function such as an NWDAF.

It will be appreciated that the network comprises a set of n of NFs that herein are denoted N={f₁, . . . , fₙ}. It will also be appreciated that the set of NFs may already be subscribed to the analytics network function. For example, they may have subscribed to receive analytic reports periodically or subscribed to receive analytics reports when a specific event occurs in the network. As a consequence, it may be assumed that the set of NFs will accept receiving analytic reports from the NWDAF. Thus, when the NWDAF detects/predicts a specific event in the network, it may proactively send analytic reports to one or more of the set of NFs.

In some examples, when subscribing to NWDAF, the NFs may set a particular attribute (e.g. “notifMethod”) to indicate they would like to be notified proactively (e.g. to “ON_EVENT_DETECTION,”). In some examples, the NFs may be able to specify one or more conditions (e.g. NetworkPerfRequirement, DnPerformanceRequirement from TS 29.520 v 18.0.0) for when they would like to be notified proactively.

For simplification purposes, herein it may be assumed that a time axis is divided into multiple time slots with equal duration Δt. By t it is denoted the time slot starting at the instant t.

At time t, if the NF fᵢ submits a request denoted rᵢ(t) to the NWDAF, then the latter may respond with the requested information in the form of an analytic report lᵢ(t). It will be appreciated that lᵢ(t) may comprise information relating to a current and a predicted network state that may assist the NF fᵢ is deciding which actions to take (or refrain from taking) in order to improve different performance metrics in the network. By s(t) is denoted the network state at t. S is the set of eventual network' states. The network state may comprise values different performance metrics (e.g. KPIs). The NWDAF may be unaware of one or more of the NF's actions when receiving analytic reports.

Generally, when receiving an analytic report lᵢ(t), the NF fᵢ interacts with the system through actions that induce a transition in the network state.

Given the complexity of the network and the different parameters that correlate, the change in the network state may not be instantaneous. It may take a variable delay before the action of the NF is effective. It may be assumed that the NWDAF knows for every NF which performance metrics (e.g. KPIs and/or statistics) of the network state may be affected by its interaction with the surrounding environment. Also, as described with reference to FIGS. 9 to 17, it may be assumed that the NWDAF is aware of the delay of the impact of each of the NFs. The delay of the impact models the time that one NF needs to make a transition in the system state, once it receives the requested analytic report.

The delay of impact may be defined as a function, d for example:

$$\begin{matrix}d : S \times \{ 1 , … , n \} \to {ℝ}^{+} \\ s ( t ) \times i \to δt ,\end{matrix}$$

Accordingly using the delay of impact function d, the NWDAF may determine the delay time δt that fᵢ needs to change the system state from s(t) to s(t+δt), ∀i∈{1, . . . , n}. t is the time when the NF reports for the analytic report. In the following, for simplicity, we denote the delay time d(s(t),i) as d(x_{i,t}).

One of the main challenges is that the different NFs might impact the same key performance metrics with different delays of the impact. For example, an action of fᵢ taken at time t may impact the traffic load 5 time slots later. And f₂ acting at time t+2 may improve the traffic load after 2-time slots. Thus, though f₂ may be contacted after f₁, it may have a quicker observable impact on the network state.

In step 401 the method comprises obtaining, at an initial time to, a prediction of a performance degradation associated with at least one performance metric at a first time, t₀+T, in the future. At the initial time to when the NWDAF predicts a future performance degradation at t₀+T, the PC-NFDI may be triggered to help alleviate the problem.

It will be appreciated that step 401 may comprise receiving a request for an analytics report from a first NF. In response to receiving the request the NWDAF may collect data from one or more data sources to generate the analytic report. In doing so, the NWDAF may make the prediction that there will be a performance degradation at the first time, t₀+T.

Responsive to obtaining the prediction in step 401, at each current time t, from t₀ to t₀+T the method may comprise performing the steps 402 and 403.

In step 402, the method comprises selecting a first set of network functions, NFs, fᵢ, wherein each network function in the first set is associated with a delay time, d(x) for the NF to impact the network, wherein for each of the first set of NFs a first condition of d(x_{i,t})<t₀+T−t is met. In other words, the NWDAF may make T decisions, where T is the time horizon of the prediction of the degradation. At every time slot t where t₀≤t<t₀+T, the NWDAF may select the set of relevant NFs.

In some examples, an action at may represent the decision of step 402 at time t. In other words, the at represents the first set of network functions where aₜ=(x_{1,t}, . . . , x_{n,t}), and x_{i,t}∈{0,1} such that x_{i,t}=1 indicates that fᵢ is in the first set of NFs, and x_{i,t}=0 indicates that fᵢ is not in the first set of NFs. It will be appreciated that, if x_{i,t}=1, then d(x_{i,t})<t₀+T−t.

The constraint d(x_{i,t})<t₀+T−t limits the number of NF's selected during every time slot. Thus, at t, NFs with a delay of the impact larger than t₀+T−t will not be considered for selection. Thus, selected NFs at t should have delays of the impacts that don't exceed t₀+T−t. This ensures that any improvement provided to the network by the selected NFs is provided before the expected degradation in the one or more performance metrics.

It will be appreciated that any NF's interaction with the environment may have no instantaneous delay of the impact. As a result, at a current time t, the objective behind the selection of step 402 may be to improve the expected future performance metrics, e.g. to avoid the predicted degradation in the one or more performance metrics.

In some examples, step 402 may be performed using time-series forecasting. For example, an ML model (e.g. a reinforcement learning, RL, model) may be trained to perform the time-series forecasting.

In step 403, the method comprises transmitting an indication of the prediction to the set of NFs. In other words, at every time slot between to and t₀+T, an analytic report, lᵢ(t) is transmitted to each of the first set of NFs selected in step 402. For example, if x_{i,t}=0, then fᵢ will not proactively receive an analytic report at t, but if x_{i,t}=1, then fⱼ will proactively receive an analytic report at t.

Step 404 illustrates how the steps 402 and 403 will be performed for each time slot from t until t₀+T. Once T≥t₀+T the process will pass to step 405 and end.

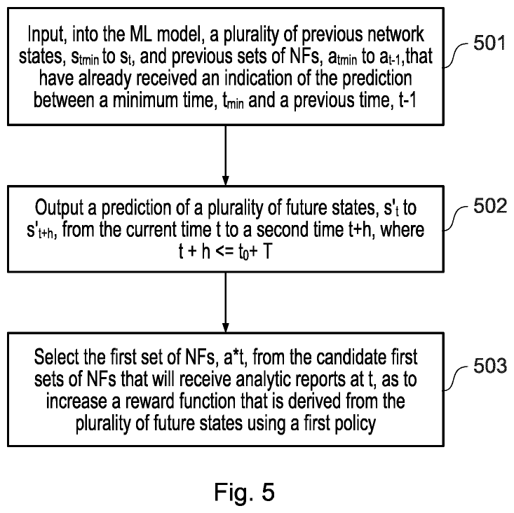

FIG. 5 illustrates an example of how step 402 may be performed utilising a ML model, in particular a reinforcement learning (RL) model.

In step 501 the method comprises inputting, into the RL model, a plurality of previous network states, sₜₘᵢₙ to sₜ, and previous sets of NFs, aₜₘᵢₙ to aₜ₋₁, that have already received an indication of the prediction between a minimum time, tmin and a previous time, t−1. Each network state sₜ comprises values of the at least one performance metric at a time t.

Based on this input, the ML model may then test a plurality of candidate first sets of NFs (e.g. candidate actions, a_{t,candidate}).

For each of the plurality of candidate first sets of NFs, in step 502 the method may therefore further comprise outputting a prediction of a plurality of future states, \tilde{s}ₜ to \tilde{s}ₜ₊ₕ, from the current time t to a second time t+h, where t+h<=t₀+T. The plurality of future states may be predicted using time series forecasting. It will be appreciated that the plurality of future network states may be determined using time series forecasting model (for example, as described in [2]).

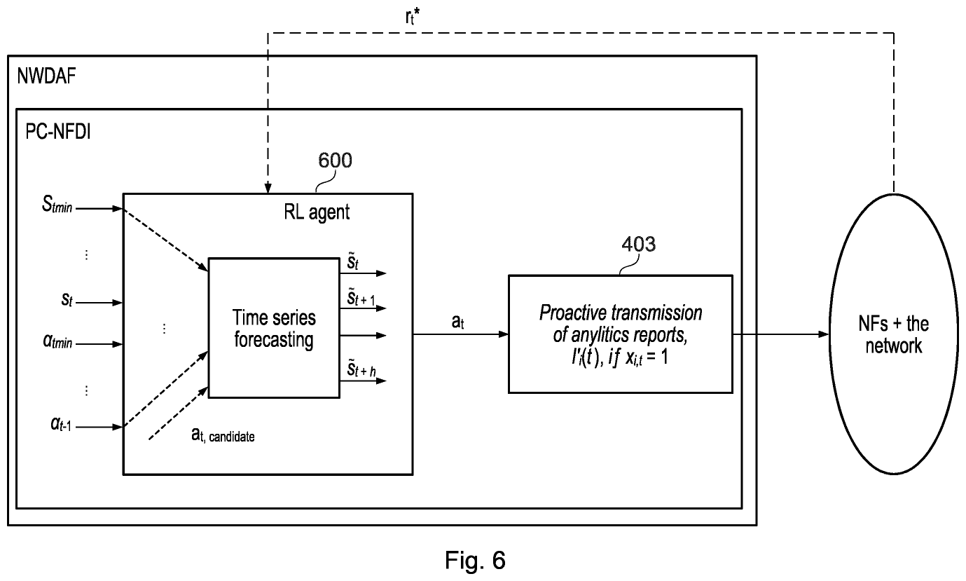

FIG. 6 illustrates an example RL model 600 according to some embodiments. FIG. 6 illustrates how the RL model 600 receives the network states sₜₘᵢₙ to sₜ, and the previous first sets of NFs, aₜₘᵢₙ to aₜ₋₁ as an input and then outputs the prediction of the plurality of futures states \tilde{s}ₜ to \tilde{s}ₜ₊ₕ, for each of the candidate first sets of NFs, a_{t,candidate}.

In step 503 the method comprises selecting the first set of NFs, at, from the candidate first sets of NFs (e.g. selecting one of the candidate actions, a_{t,candidate}), that will receive analytic reports at t, as to increase (e.g. maximize) a reward function that is derived from the plurality of future states using a first policy.

It will be appreciated that responsive to transmitting the indication of the prediction to the set of NFs (e.g. in step 403), the method of FIG. 4 may further comprise receiving an actual reward,

$${r}_{t}^{*} ,$$

from the network (e.g. as a result of the actions performed by the set of NFs in response to the transmission in step 403), and updating the first policy based on the actual reward. In other words, the first policy used to determine the reward function based on the plurality of future states may be learnt using reinforcement learning. The actual reward,

$${r}_{t}^{*} ,$$

may be derived from improvements in the one or more performance metrics. As described with reference to FIGS. 9 to 17, the NWDAF may observe the improvements in the one or more performance metrics in the network.

The reward function may, for example, be expressed as:

$${max}_{{a}_{t}} {\sum }_{t} {γ}^{t} {\tilde{r}}_{{t}_{min}}^{t}$$

This example reward function comprises a cumulative expected reward between the minimum time, tₘᵢₙ and the second time t+h that is representative of an improvement in the at least one performance metric.

$${\tilde{r}}_{{t}_{min}}^{t}$$

model the expected value of the improvement in the one or more performance metrics, based on the series of actions between tₘᵢₙ and t (e.g. (aₜ_{ₘᵢₙ}, . . . , aₜ₋₁, aₜ).

It will be appreciated that this reward function therefore considers the previous decision making (e.g. the actions aₜ_{ₘᵢₙ}, . . . , aₜ₋₁, aₜ) in order to account for the temporal dependencies between the NFs interactions with the surrounding environment. For example, if at t₀, NWDAF selects only f₁ which will impact the traffic load at t₀+5. Then, at

$${t}_{0} , {\tilde{r}}_{{t}_{min}}^{{t}_{0}}$$

is defined as the expected reward at t₀+5, e.g., the improvement in the traffic load at t₀+5.

In some examples, the reward function comprises a discounted cumulative expected reward that comprises a discount factor γ^{t}. The discount factor may be utilised to reduce or increase the impact of expected reward

$${\tilde{r}}_{{t}_{min}}^{t}$$

for times further away from the current time. As the primary goal is to improve the performance metric at the first time t₀+T, the discount may be used to place a greater weighting on expected rewards for time slots that are closer to the first time t₀+T.

In some examples, tₘᵢₙ is equal to the initial time, t₀. However, to reduce the set of actions with correlated impacts that are considered when determining the reward

$${\tilde{r}}_{{t}_{min}}^{t}$$

the variable tₘᵢₙ may, in some examples, be initialised and then updated.

For example, at the initial time to, the method of FIG. 5 may comprise setting tₘᵢₙ=t₀. Then, responsive to, at the current time t the first set of NFs comprising an NF that provides an impact at a later point in time than any other NF selected in the times tₘᵢₙ to t−1, the method may comprise resetting tₘᵢₙ=t.

The pseudocode below illustrates an example of how tₘᵢₙ may be initialised and set.

```
Input
tₘᵢₙ + t₀
${a}_{{t}_{0}} ← ( {x}_{1 , {t}_{0} , ⋯ , {x}_{n , {t}_{0}}} ) \backslash \backslash Select the relevant NFs at {t}_{0}$
M ← max(d(x_{1,t}_{₀}) ... , d(x_{n,t}_{₀}) \\ M is the longest delay of the impact of the NFS selected at
t₀
For t ∈ {t₀ + 1, ... , t₀ + T}:
    B ← true
  | If t = = tₘᵢₙ + M
  | B ← false
  | t* ← tₘᵢₙ + 1
  | While (! B) and (t* < t):
  | | |If (max (d(x_{1,t}_{^{*}}), ... , d(x_{n,t}_{^{*}})) where d(x_{i,t}_{^{*}}) + t* > M + tₘᵢₙ)  \\ using
  | | |at*, check if there exists one delay of the impact higher than M
  | | |M ← max (d(x_{1,t}_{^{*}}, ... , x_{n,t}_{^{*}})) \\update M to d(xi,t* ), the NF i has the max
  | | |delay of the impact with the following condition d(xi,t*)+t*>M+tmin
  | | tₘᵢₙ ← t*
  | B ← true
  | endif
        t* ← t* + 1
      endwhile
      if (!B):
      | tₘᵢₙ ← t
      endif
      endif
      aₜ ← (x_{1,t}, ... , x_{n,t}) \\ Select the relevant NFs at t
  | if (!B):
      M ← max (d(x_{1,t}, ... > x_{n,t}))
      endif
endfor
```

For example, assume that f₁ and f₂ are selected at to, i.e., x_{1,t}_{₀}=1 and x_{2,t}_{₀}=1. In this example, f₁ will impact the traffic load 5 time slots in the future, e.g. at t₀+5, and f₂ will impact the traffic load 2 time slots in the future, e.g. at t₀+2.

In the next time slot, t₀+1, f₂ is selected. f₃ will impact the traffic load 6 time slots in the future, e.g. at t₀+7.

Assume for simplicity that no other NFs are selected between t₀+1 and t₀+5.

At t₀+5 the impact of both f₁ and f₂ are realized thus tₘᵢₙ is updated to t₀+1 because f3 was selected at t₀+1 (after f₁ and f₂) and its impact is not yet observable thus here only the NFs selected starting from t₀+1 will be included in the reward function.

Then, at t₀+7, when the impact of f₃ is observable, if at t₀+5 an fa was selected which will impact the traffic load for example 3 slots in the future, e.g. at t₀+8, then tₘᵢₙ will be reset at t₀+5. Conversely, if at t₀+5 an f₅ is selected which will impact the traffic load for example 1 time slot in the future, e.g. at t₀+6 then, at t₀+7 tₘᵢₙ will be reset, to the current time slot t₀+7 because all the previously selected NFs had realized their delay of impact.

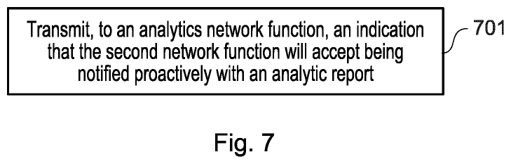

FIG. 7 illustrates a method in a second network function for avoiding degradation of performance of one or more performance metrics in a network.

The method 700 may be performed by a network node, which may comprise a physical or virtual node, and may be implemented in a computing device or server apparatus and/or in a virtualized environment, for example in a cloud, edge cloud or fog deployment. In particular, the method 700 may be performed by a second network function that is a service consumer of an NWDAF.

In step 701 the method comprises transmitting, to an analytics network function, an indication that the second network function will accept being notified proactively with an analytic report. It will be appreciated that the analytics network function may comprise an NWDAF. It will also be appreciated that the second network function may comprise one of the first set of NFs selected by an NWDAF in step 402.

In other words, in some examples, when subscribing to NWDAF, the NFs may set a particular attribute (e.g. “notifMethod”) to indicate they would like to be notified proactively (e.g. to “ON_EVENT_DETECTION,”). In some examples, the NFs may be able to specify one or more conditions (e.g. NetworkPerfRequirement, DnPerformanceRequirement) for when they would like to be notified proactively.

It will be appreciated that in some examples an NF may only be selected as one of the first set of NFs in step 402 if they have transmitted an indication according to the method of FIG. 7.

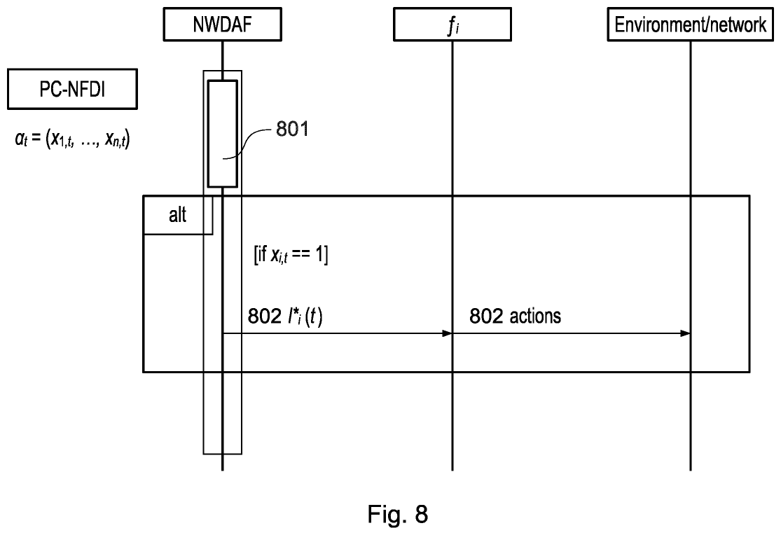

FIG. 8 is a signalling diagram illustrating an example implementation of the methods of FIGS. 4 to 7.

In step 801, the NWDAF performs steps 401 and 402 of FIG. 4.

In step 802, the NWDAF then performs step 403 of FIG. 4 and transmits an analytic report to the NF fᵢ. The NF fᵢ then performs an action in the network.

FIG. 9 illustrates an example in which network state transitions to a new network state due to the interaction of just one NF, e.g. NF1.

In step 901, the NF1 subscribes to receive analytic reports from the NWDAF. For example the NF1 may subscribe to receive analytic reports about predicted changes to a particular performance metric.

In step 902, the NF2 subscribed to receive analytic reports from the NWDAF. For example, the NF2 may subscribe to receive the same analytic reports as the NF1, or may subscribe to receive different analytic reports.

In some examples, after subscribing to receive analytic reports the NF1 may request an analytic report, as illustrated in step 903. It will be appreciated that in some cases the subscription may indicate particular circumstances in which analytic reports should be sent to an NF. In these cases, the NF may not need to send individual requests for analytic reports.

In step 904, the NWDAF transmits an analytic report to NF1.

In step 905, the NF1 performs an action in the environment. At a later time, the network state changes from an initial state X₁ to a new state X₂.

In this scenario, calculating the delay of the impact might easily be learned since the NWDAF does not send an analytic report to NF2, (or they are transmitted sufficiently earlier than request of step 903 or occur after the state change). Alternatively, or additionally, in this example it may be assumed that one NF can't receive a report from the NWDAF until another NF achieves its goal in terms of performance metric improvement.

Therefore, in FIG. 9, the new state X₂ may be determined to be the impact of NF1's interaction with the network and the transition from X₁ to X₂ is thus the result of the NF1's interaction in the environment. The delay of impact for NF1 may therefore be the time between the receipt of step 904 and the change to the new state X₂.

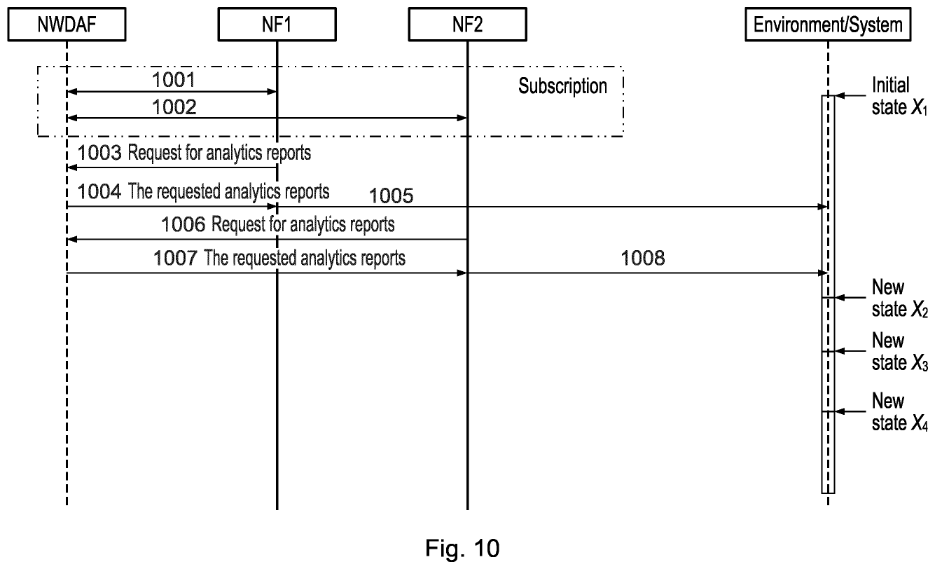

FIG. 10 illustrates how the performance metrics may change when there is an overlap between two or more NFs' interactions with the environment, i.e., NFs impacting non-disjoint sets of performance metrics.

Steps 1001 to 1005 correspond to steps 901 to 905 of FIG. 3.

However, in FIG. 4, in step 1006, the NF2 requests an analytics report. In step 1007, the NWDAF transmits an analytic report to the NF2. It will be appreciated that in some circumstances the request of step 1006 is omitted as the NF2 has subscribed to receive relevant analytic reports.

In step 1008 the NF2 performs an action in the environment.

In this example, at a later time than both of steps 1005 and 1008, the network state changes from an initial state X₁ to a new state X₂. The state of the network may then evolve further, for example into states X₃ and X₄.

In this example, therefore, the first variation in the network state appears after both NF1 and NF2 have interacted with the environment. Thus, it is challenging for the NWDAF to understand which NF is impacting the network state to cause the transitions from X₁ to X₂.

In order to overcome this issue, embodiments described herein enable the NWDAF to learn and understand how and when the network state will vary over the course of time, without any knowledge about the various NF's actions. Long and short-term dependency patterns between the NFs' requested analytics reports and the transition in specific performance metrics may be used to introduce a framework that enables the NWDAF to learn and understand the delay required by one NF to make observable transitions in the network state. Finally, using the learned delay of the impact, the NWDAF may be able to provide NFs with additional information about the expected network state variations over time. By receiving knowledge about expected network state variations due to actions from other NFs, a NF may be able to trigger (or refrain from triggering) proper action(s) to reach a desired state of the network.

Embodiments described herein enable the NWDAF to learn the delay of the impact for each NF. For example, by utilizing the time series forecasting methods and/or temporal attention mechanisms, the NWDAF may learn how the environment will change over time. Once a NF receives an analytic report, the NWDAF may then predict when the network state will transition to a new one. Moreover, this functionality, may deal with the overlap between different NFs' interactions with the network state, i.e., the NFs that impact non-disjoint sets of performance metrics during the same period. As a result, NWDAF may quantify one NF's impact on the network state.

Based on the learned delay of the impact, in some embodiments, the NWDAF may provide the NFs with additional information about the network state transition when an analytic report is requested. This further information may indicate how the NFs interacting with the network during a time period relevant to the requesting NF will impact the network states. Accordingly, some NFs may receive this additional information along with their requested analytic reports.

It will be appreciated that subscribed NFs may transmit individual requests to the NWDAF to receive predictions relating to performance metrics within the network states they are interested in.

It will also be appreciated that an NF may analyse any received analytic report, and may or may not interact with its surrounding environment to make some changes in the network state in response to receiving the analytic report.

To enable NWDAF to learn the delay of the impact of the different NFs' interactions, one or more of the following may be assumed:
1) For each NF, the NWDAF already knows:
   The set of performance metrics, e.g., delay, throughput, etc., that may be impacted by the NF interacting with the network. Thus, NWDAF knows the relevant dimensions of the state space on which every NF acts.
   The request time distribution, i.e., frequency of submitting a request for notifications.
   The maximum delay of the impact of every NF interaction with the systems. The maximum delay of the impact may be estimated based on the time scale of the NF's requested analytic reports.
      For simplicity, it may be considered that the maximum delay of the impact is limited to the periodicity of receiving a request for an analytic report. For example, if one NF sends a request for an analytic report every 2 s, then its delay of the impact may be assumed not to exceed 2 s.
      For non-periodic requests, it may be assumed that the NWDAF is configured with a maximum threshold to limit the delay of the impact.
2) The NWDAF has limited observations about each NF's decided action every time it receives an analytic report. The NWDAF may instead observe variations in performance metrics based on the actions taken in response to analytic reports transmitted to one or more NFs. For example, when NF1 receives an analytical report, NWDAF may observe a variation in traffic load.
3) Different eventual possible actions may be considered by the NFs, for example, the management of the Physical Resource Blocks (PRBs), the traffic scheduling, etc.

Herein NFs are described as being able to make actions in the network. It will be appreciated that to make an action in the network the NF may adjust one or more network parameters which may have an effect on one or more performance metrics (e.g. KPIs). However, the variation in these performance metrics may not be instantaneous.

The following comprises examples of possible performance metrics that may be altered by the actions of NFs in a network:
Number of retransmissions
Data rates
Active power-saving features for radio units
Active RAN features in a specific network, such as Microsleep TX, Less, MINO, etc
Power consumption

For each performance metric, one or more NFs may be able to take an action in the network in order to adjust the performance metrics. The following comprises examples of possible actions in the network:
Offload to other cells
Offload to other cells, or use dual-band
Delay of a power amplifier (PA) switching ON and OFF
Schedule/or reschedule re-coordination of RAN features to be active.

For example, reducing the delay may result in lower power consumption, or by adding a new band to reduce the interference may improve the quality of service.

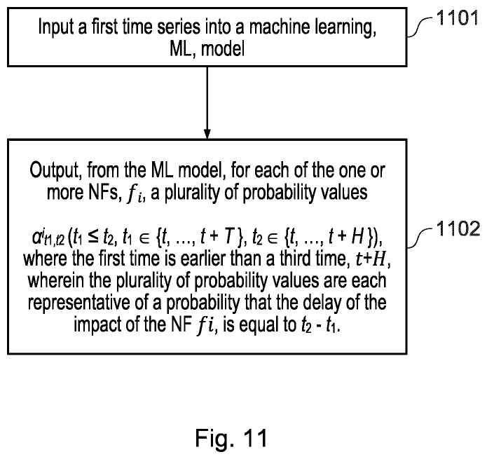

FIG. 11 illustrates a computer-implemented method for learning a delay of impact of one or more network functions' interactions with a network. The one or more NFs may be grouped together according to which performance metrics the one or more NFs may change in the network.

To learn the delay of the impact of the NF interactions with the network, a ML model may be used. The main objectives of the proposed model are:
Learning/predicting how the network state will change during every time slot.
Quantifying the participation of every NF in the network's state transitions. This quantification may be presented in terms of probabilities, as will be described below.

The method 1100 may be performed by a network function, which may comprise a physical or virtual node, and may be implemented in a computing device or server apparatus and/or in a virtualized environment, for example in a cloud, edge cloud or fog deployment. It will be appreciated that the method 1100 may be performed by a NWDAF.

To enable NWDAF performing the method of FIG. 11 to follow the variation in the network's state, it may be assumed that the time axis can be divided into several time slots with equal lengths Δt, The duration of one slot Δt may be set equal to the shortest duration that separates two consecutive requests for analytical reports from the same NF.

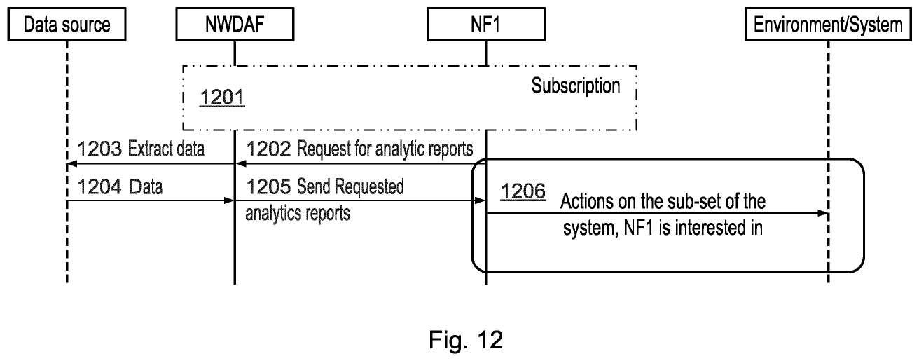

It may be understood that F={fᵢ, . . . , fₙ} comprises a set of one or more NFs. By t and rᵢ(t) are denoted the time slot starting at instant t and a request sent by fᵢ at t to NWDAF, respectively. As depicted in FIG. 12, once f; transmits the request rᵢ(t), the NWDAF may answer with the requested analytic report that is denoted as lᵢ(t). FIG. 12 illustrates an example in which fᵢ subscribes to receive analytic reports in step 1201. In step 1202 fᵢ submits a request rᵢ(t). In steps 1203 and 1204 the NWDAF collects data for the analytic report from a data source. In step 1205, the NWDAF transmits the analytic report lᵢ(t) to fᵢ.

In step 1206 fᵢ performs an action in the network in response to the information in the analytic report lᵢ(t).

However, as depicted in FIG. 10, different NFs might interact with the surrounding environment during the same period. As a result, they might impact correlated or the same performance metrics. For example, in FIG. 10, the first variation in the system state appears after f₁ and f₂ have both received their requested analytic reports, l₁ and l₂, respectively. As a result, they might have a joint impact on the system state transition.

The notation xₜ, denotes the state information related to one or more performance metrics in the network at time t. x(t)∈ [symbol] ^{m}, m∈ [symbol] where m may represent the number of performance metrics that are used to describe the network state. By xᵢ is denoted a set of performance metrics that fᵢ is interested in.

In this example, it may be assumed that:
Every pair of NFs act on a non-empty set of joint features: ∀fᵢ,fⱼ∈F, xᵢ∩xⱼ≠Ø; and
In one time slot, only one NF may transmit a request for an analytic report, and only one NF may start to interact with the network environment.

In step 1101 the method comprises inputting a first time series into a machine learning, ML, model. It will be appreciated that the ML model may be trained and used by the NWDAFs for the one or more NFs. The NWDAF may produce and train other ML models for other groups of NFs which are, for example, able to change other types of performance metrics in the network.

The first time series comprises: analytics information, L_{t→t+T}, relating to whether an analytics report was transmitted to each of the one or more NFs between an initial time t and a first time t+T. For example, the analytics information may comprise, for example of the one or more NFs, fᵢ, an analytic report value, lᵢ(t) for each time t→t+T. For example:

$$, {L}_{t \to t + T} = \{ l ( t ) , l ( t + 1 ) , … , l ( t + T ) \} , and l ( t ) ∈ {ℝ}^{n} , l ( t ) = [ \begin{matrix}{l}_{1} ( t ) \\ {l}_{2} ( t ) \\ ⋮ \\ {l}_{n} ( t )\end{matrix} ] ,$$

where
i∈{1, . . . , n}. n is the total number of NFs. lᵢ(t) is the analytic report/prediction sent to fᵢ at t. lᵢ(t)∈[X, Y] if the NF fᵢ was transmitted an analytic report at time t. If fᵢ was not transmitted an analytic report at t, then lᵢ(t) equals Z∉[X, Y]. In some examples X=0, Y=1 and Z=−1.

The first time series further comprises: state information, x(t), related to one or more performance metrics in the network between the initial time t and the first time, t+T. The state information comprises a time series x(t)∈ [symbol] ^{m} that represents the network state (e.g. the one or more performance metrics in the network).

More formally, the first time series Y_{t→T} may be expressed as:

$${Y}_{t \to t + T} = \{ y ( t ) , y ( t + 1 ) , … , y ( T + T ) \} ← \{ ( x ( t ) , l ( t ) ) , ( x ( t + 1 ) , l ( t + 1 ) ) , ⋯ , ( x ( t + T ) , l ( t + T ) ) \}$$

In step 502 the method comprises outputting, from the ML model, for each of the one or more NFs, fᵢ a plurality of probability values

$${α}_{{t}_{1} , {t}_{2}}^{i} ( {t}_{1} \leq {t}_{2} , {t}_{1} ∈ \{ t , …t + T \} , {t}_{2} ∈ \{ t , … , t + H \} ) ,$$

where the first time t+T is earlier than a third time, t+H, wherein the plurality of probability values are each representative of a probability that the delay of the impact of the NF fᵢ is equal to t2−t₁. In other words, fᵢ is participating in the system state's transition from x(t₁) to x(t₂) with a probability equal to

$${α}_{{t}_{1} , {t}_{2}}^{i} .$$

### Also,

$${α}_{{t}_{1} , {t}_{2}}^{i}$$

indicates the conditional probability that the predicted system state transits from x(t₁) at t₁ to x(t₂) at t₂ given that fᵢ received lᵢ at t₁, i.e.,

$${α}_{{t}_{1} , {t}_{2}}^{i} = P ( x ( {t}_{1} ) \to x ( {t}_{2} ) / {l}_{i} ( {t}_{1} ) ) .$$

In some examples, the method of FIG. 11 may further comprise deriving a second time series comprising predicted values, \hat{x}(t), of the state information between the first time, t, and a third time, t+H. The second time series may be defined as:

$${X}_{t \to t + H} = \{ \hat{x} ( t ) , \hat{x} ( t + 1 ) , … , \hat{x} ( t + T ) , … , \hat{x} ( t + H ) \}$$

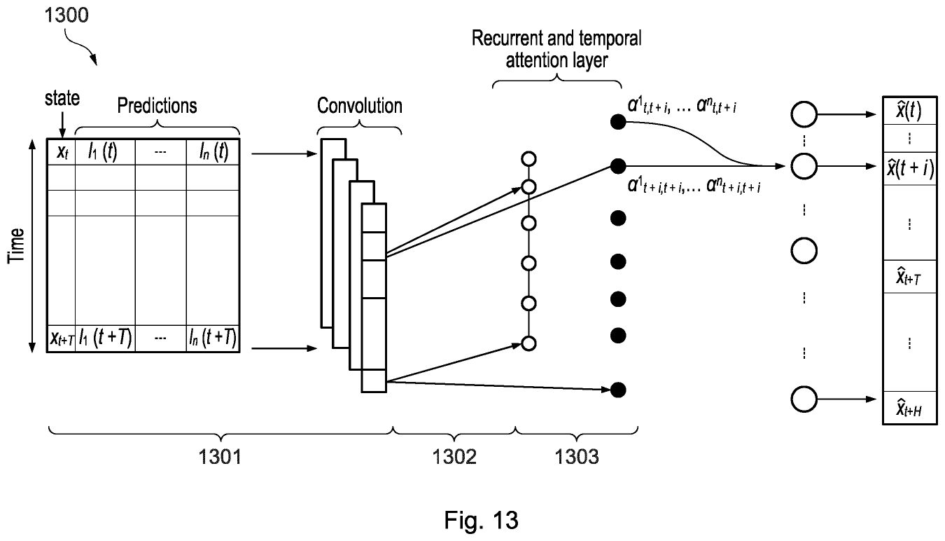

It will be appreciated that the second time series is derived from the plurality of probability values for each of the one or more NFs (for example, as illustrated later with reference to FIG. 13).

The second time series \hat{X}_{t→t+H} comprises a concatenation of two lists \hat{X}_{t→t+T}←{\hat{x}(t), . . . \hat{x}(t+T)} and \hat{X}_{t+T+1→t+H}←{\hat{x}(t+T+1), . . . , \hat{x}(t+H)}. \hat{X}_{t→t+T} presents a prediction of a part of first time series Y_{t→T}. In other words, \hat{X}_{t→t+T} is a prediction of X_{t→t+T}=(x(t), . . . , x(t+T). X_{t→t+T} is predicted in the output \hat{X}_{t→t+H} in order to learn the impact on the network states {x(t′+1), . . . , x(t+T)} of every NF's interactions performed during the times t′∈{t, . . . , T} given the received analytic reports lᵢ(t′).

It will be appreciated that the ML model may be trained such that the prediction \hat{X}_{t→t+T} converges to the actual values of X_{t→t+T}=(x(t), . . . , x(t+T)).

The method of FIG. 11 may therefore comprise training the ML model by updating one or more parameters of the ML model to minimise a loss function derived from the state information, x(t), and the second time series, x′(t).

The minimisation of the loss function may be expressed as:

$${min}_{θ} {\sum }_{t ∈ {Ω}_{Train}} \vert x ( t ) - \text{?} \vert$$

where θ denotes the parameter set of the ML model, Ω_{Train} comprises a set of time stamps used for training (e.g. t to t+T), and

$${min}_{θ} {\sum }_{t ∈ {Ω}_{Train}} {\vert x ( t ) - \hat{x ( t )} \vert}_{F}^{2}$$

is the Frobenius norm.

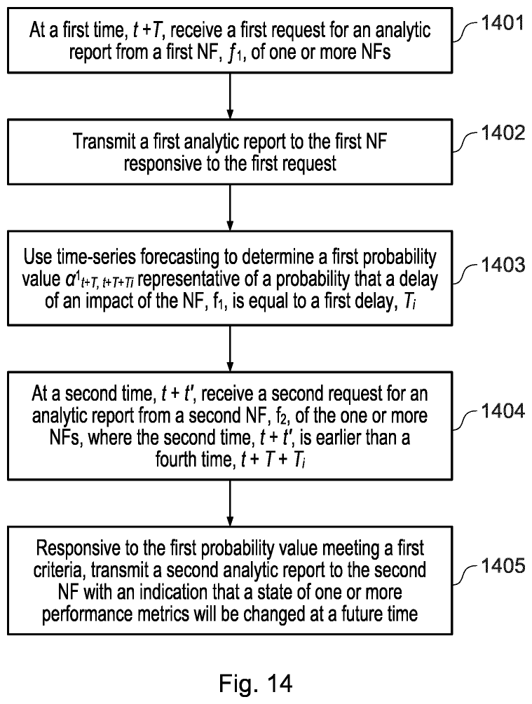

The plurality of probability values output in step 1102 may be utilised to transmit an indication of NFs that state information will change from current state information at some point in the future (e.g. as will be described in more detail with reference to FIG. 14). However, the probability values may be used in one or more other ways. For example, if a particular probability value is higher than a predetermined threshold, then NWDAF may use it to update future predictions about the network state, which may, in turn, have an effect on future analytic reports.

It will also be appreciated that, based on the output probabilities, the NWDAF may delay processing of other requests for analytic reports until the (predicted) time indicates that the network has been impacted, in order to avoid conflict.

The ML model may comprise any form of suitable ML model, for example an artificial neural network (ANN). In some examples, the ML model comprise one or more of: a Convolutional Neural Network layer, a recurrent layer, and a temporal attention layer.

FIG. 13 illustrates an example of the ML model 1300.

The ML model 1300 comprises a CNN layer 1301 (e.g. a CNN layer without pooling).

The CNN layer 1301 may for example aim to extract short-term patterns in the time dimension as well as local dependencies between the NF's requested analytic reports, and thereby the potential impact on the network state, i.e., the performance metrics.

The ML model 1300 also comprises a recurrent layer 1302. The recurrent layer 1302 may be used to memorize historical information and therefore to be aware of relatively long-term dependencies in input data.

The ML model also comprises a temporal attention layer 1303. The temporal attention layer 1303 may output the probabilities,

$${α}_{{t}_{1} , {t}_{2}}^{i} .$$

The second time series Rt-H may then be derived from the probabilities

$${α}_{{t}_{1} , {t}_{2}}^{i} .$$

For example, the state \hat{x}(t+i) may be derived from all probabilities where t₂=t+i.

FIG. 14 illustrates a computer-implemented method for transmitting analytic reports to one or more NFs in a network.

The method 1400 may be performed by a network function, which may comprise a physical or virtual node, and may be implemented in a computing device or server apparatus and/or in a virtualized environment, for example in a cloud, edge cloud or fog deployment. It will be appreciated that the method 800 may be performed by an analytics network function, e.g. a NWDAF.

In step 1401, the method comprises at a first time, t+T, receiving a first request for an analytic report from a first NF, f₁, of one or more NFs.

In step 1402, the method comprises transmitting a first analytic report to the first NF responsive to the first request.

In step 1403, the method comprises using time-series forecasting to determine a first probability value

$${α}_{t + T , t + T + {T}_{i}}^{1} .$$

Representative of a probability that a delay of an impact of the NF, f, is equal to Tᵢ. Step 803 may comprise utilising the method as described with reference to FIG. 5 to determine the probability value

$${α}_{t + T , t + T + {T}_{i}}^{1} .$$

It will be appreciated that other methods, which may or may not utilise machine learning, may be used to determine the first probability value.

In step 1404 the method comprises at a second time, t+t′, receiving a second request for an analytic report from a second NF, f₂, of the one or more NFs, where the second time, t+t′, is earlier than a fourth time, t+T+Tᵢ.

In step 1405, responsive to the first probability value meeting a first criteria, transmitting a second analytic report to the second NF with an indication that a state of one or more performance metrics will be changed at a future time. The first criteria may comprise comparing the first probability value to a predetermined threshold. For example, if the first probability value is greater or equal to the predetermined threshold this may indicate that the state of the one or more performance metrics is likely to change as predicted, and that therefore it would be useful to transmit this indication to the second NF. In other words, the first probability value may be considered to meet the first criteria if it is greater than or equal to a first predetermined threshold value.

However, if the first probability value does not meet the first criteria, the method may comprise refraining from transmitting, to the second NF, the indication that the state of the one or more performance metrics will be changed at the future time. In this example, the method may simply comprise transmitting the second analytic report to the second NF without the indication.

In some examples, the indication that a state of one or more performance metrics will be changed at a future time may only be transmitted to the second NF is a subscription request has been received from the second NF subscribing to receive predicted values of state information.

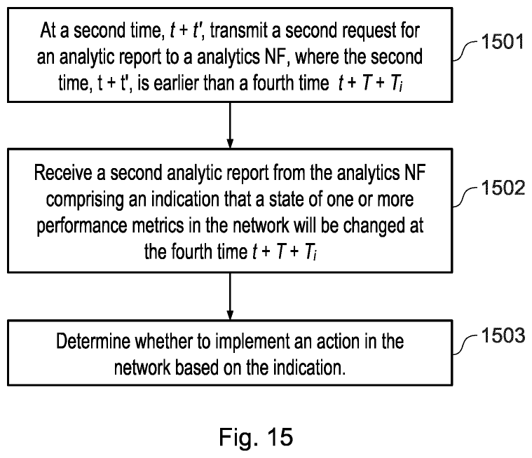

FIG. 15 illustrates a method, in a second network function, for utilising analytic reports.

The method 1500 may be performed by a network function, which may comprise a physical or virtual node, and may be implemented in a computing device or server apparatus and/or in a virtualized environment, for example in a cloud, edge cloud or fog deployment. It will be appreciated that the method 800 may be a NF that is consuming the services of an NWDAF.

In step 1501, at a second time, t+t′, the method comprises transmitting a second request for an analytic report to an analytics network function, where the second time, t+t′, is earlier than a fourth time, t+T+Tᵢ.

In step 1502, the method comprises receiving a second analytic report from the analytics network function comprising an indication that a state of one or more performance metrics in the network will be changed at the fourth time t+T+Ti.

In step 1503, the method comprises determining whether to implement an action in the network based on the indication. For example, the NF may decide to refrain from performing any action in the network that it would otherwise have performed in response to the second analytic report as the prediction of the state at the fourth time means that the action is not going to be necessary.

In other words, based on the previously learned information, i.e., the predicted future system state and the probability that one NF is impacting the variation in this network state, the methods of FIGS. 14 and 15 look to provide the NFs with additional information (e.g. the indication of step 1502). This additional information indicates how the network state will change based on the other NFs interactions with the network.

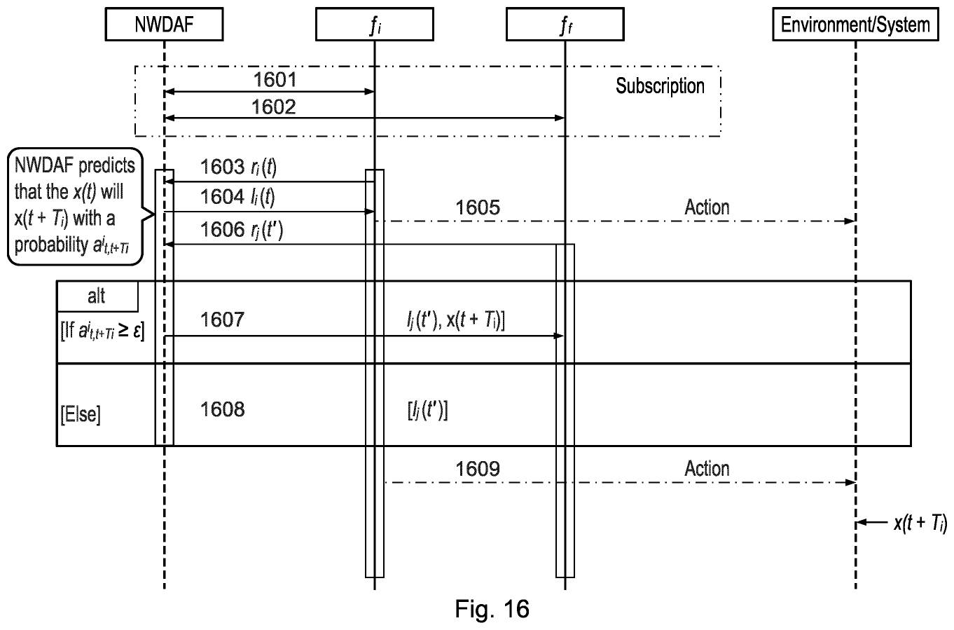

FIG. 16 is a signalling diagram illustrating an example implementation of the methods of FIGS. 14 and 15.

In step 1601 and 1602 the NFs fᵢ and fⱼ subscribe to predicted values of state information.

In step 1603 at a first time, t+T, the NWDAF receives a first request for an analytic report from a first NF, f₁, of one or more NFs. Step 1003 comprises an example implementation of step 1401 of FIG. 14

The NWDAF uses time-series forecasting (for example, as described above) to determine a first probability value

$${α}_{t + T , t + T + {T}_{i}}^{1}$$

representative of a probability that a delay of an impact of the NF, f₁, is equal to Tᵢ.

In step 1604, the NWDAF transmits a first analytic report to the first NF responsive to the first request. Step 1604 corresponds to step 1402

In step 1605, the first NF performs an action in the network in response to the first analytic report.

In step 1606, at a second time, t+t′, the NWDAF receives a second request for an analytic report from a second NF, f₂, of the one or more NFs, where the second time, t+t′, is earlier than a fourth time, t+T+Tᵢ. Step 1606 corresponds to 1404 and step 1501.

In step 1607, responsive to

$${α}_{t + T , t + T + {T}_{i}}^{1} \geq ε ,$$

transmitting a second analytic report to the second NF with a prediction of the network state x(t+T+Tᵢ). In this example, ε is a threshold that may be designed to ensure the reliability of the predictions. Step 1607 corresponds to steps 1105 and 1502.

However, if

$${α}_{t + T , t + T + {T}_{i}}^{1} < ε ,$$

then the NWDAF only transmits lⱼ(t′) to fⱼ in step 1608. In both cases, upon receipt of either step 1607 or 1608 fⱼ will make a decision about any actions to perform in the network (e.g. step 1609) based on the received information.

Therefore, if the fⱼ receives the indication of the state prediction x(t+T+Tᵢ), it obtains additional and richer information about how the network state will change during the time fⱼ may interact with the network.

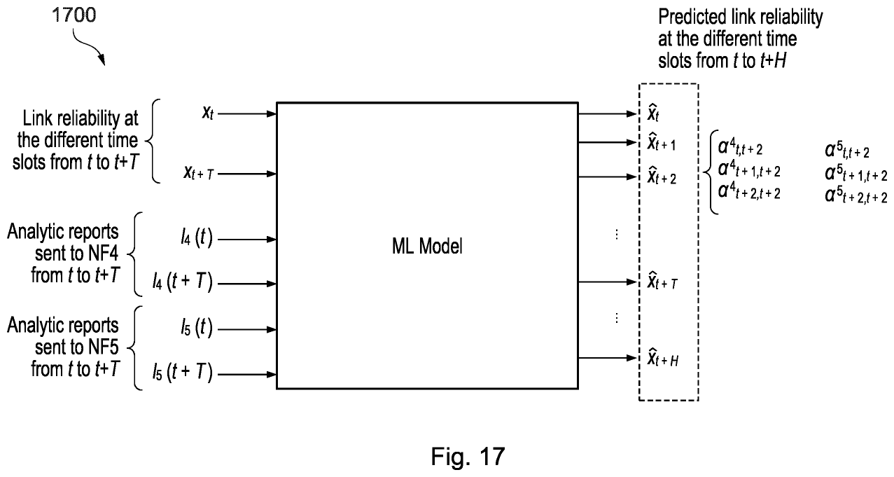

FIG. 17 illustrates an example of the inputs and outputs of the ML model 1700 according to some embodiments.

In this example, the network comprises 4 NFs, e.g. NF1, NF2, NF3, and NF4. The following indicates what these example NFs control and the performance metrics that may be changes by their actions in the network.

In this example NF1:
Controls the PRB allocation per traffic slice; and
Impacts the traffic delay and the traffic load

In this example NF2:
Is responsible for the traffic scheduling; and
Impacts the traffic delay and the traffic load

In this example NF3:
Switches ON/OFF deployed cells/antennas; and
Impacts the traffic load, delay, and energy consumption

In this example NF4:
Manages the number of re-transmissions; and
Impacts link reliability

In this example NF5:
Manages the antenna power transmission; and
Impacts link reliability and energy consumption.

Based on the set of performance metrics that the various NFs' actions may impact, the NWDAF may group these example NFs into three groups. It will be appreciated that the NFs may be grouped such that a group of NFs affects the same or non-disjoint sets of performance metrics.

For example, the 4 example NFs may be grouped as follows:
Group 1={NF1, NF2, NF3, NF5}. This group focus on the system traffic delay and load.
Group 2={NF3, NF 5}. This group is interested in energy consumption
Group 3={NF4, NF5}. This group is interested in link reliability.

Accordingly, for every group of NFs, the NWDAF may produce specific trained ML model (e.g. as described with reference to FIG. 5).

The ML model for group 1 learns the network state variation during the time. Here, the network state comprises the traffic load and delay. Thus, the ML model will learn how the traffic delay and load will change based on analytic reports sent to NF1, NF2, NF3, and NF5. Also, the NWDAF may analyse how much, e.g. with what probability, every NFs is impacting the network state at different times.

The network state for group 2 may comprise the energy consumption during every time slot.

The network state for group 3 may comprise link reliability at every time slot.

FIG. 17 in particular depicts the ML model 1700 for group 3 which comprises NF4 and NF5.

The link reliability values for the times t to t+T are input into the ML model as the network state information. The analytics information comprises the analytic reports transmits to the NF4 and NF5 between the times t and t+T. The ML model then outputs the probabilities

$${a}_{t , t}^{j} ,$$

where j∈{4,5}, and these probabilities are used to determine predications of the link reliability from the times t to t+H.

Returning to the description of FIG. 16, consider if fᵢ=NF5 and fⱼ=NF4.

The analytic report transmitted in step 1604 may indicate that the link reliability will drop to 0.3 at t+4. This may be considered very low. The ML model may then predict that NF5 will improve the link reliability (due to performing an action to increase antenna power transmission in step 1005) at t+5, to 0.9.

After that, at t+1, in step 1606 NF4 asks for the same analytic report, i.e., the link reliability at t+4. In this example it is assumed that the probability of the prediction that NF5 will improve the link reliability at t+5 is greater than the predetermined threshold. Therefore, in this example, NWDAF will transmit (e.g. in step 1008) the default analytic report, i.e., the link reliability equals 0.3 at t+4 to NF4 along with the indication that the link reliability at t+5 will increase to 0.9.

In this case, therefore NF4 might not increase the number of re-transmissions in response to the received analytic report because NF5 has already acted to improve the link reliability, and, in some examples, NF5 has a shorter delay of the impacts.

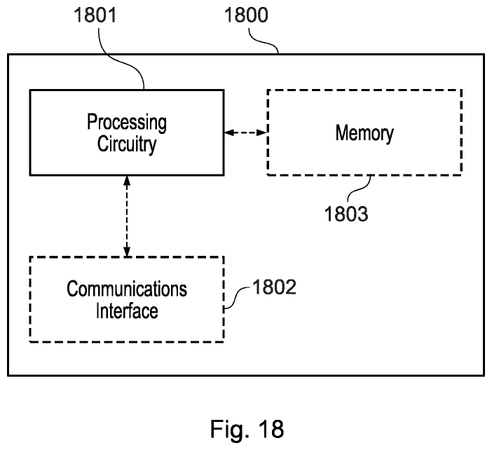

FIG. 18 illustrates a network function 1800 comprising processing circuitry (or logic) 1801. The processing circuitry 1801 controls the operation of the network function 1800 and can implement the method described herein in relation to an network function 1800. The processing circuitry 1801 can comprise one or more processors, processing units, multi-core processors or modules that are configured or programmed to control the network function 1800 in the manner described herein. In particular implementations, the processing circuitry 1801 can comprise a plurality of software and/or hardware modules that are each configured to perform, or are for performing, individual or multiple steps of the method described herein in relation to the network function 1800. It will be appreciated that the network function 1800 may comprise one or more virtual machines running different software and/or processes. The network function 1800 may therefore comprise, or be implemented in or as one or more servers, switches and/or storage devices and/or may comprise cloud computing infrastructure that runs the software and/or processes.

Briefly, the processing circuitry 1801 of the network function 1800 is configured to perform the method as described herein with reference to a first network function, a second network function or a NWDAF.

In some embodiments, the network function 1800 may optionally comprise a communications interface 1802. The communications interface 1802 of the network function 1800 can be for use in communicating with other nodes, such as other virtual nodes. For example, the communications interface 1802 of the network function 1800 can be configured to transmit to and/or receive from other nodes requests, resources, information, data, signals, or similar. The processing circuitry 1801 of network function 1800 may be configured to control the communications interface 1802 of the network function 1800 to transmit to and/or receive from other nodes requests, resources, information, data, signals, or similar. The communications interface 1802 can use any suitable communication technology.

Optionally, the network function 1800 may comprise a memory 1803. In some embodiments, the memory 1803 of the network function 1800 can be configured to store program code that can be executed by the processing circuitry 1801 of the network function 1800 to perform the method described herein in relation to the network function 1800. Alternatively or in addition, the memory 1803 of the network function 1800, can be configured to store any requests, resources, information, data, signals, or similar that are described herein. The processing circuitry 1801 of the network function 1800 may be configured to control the memory 1803 of the network function 1800 to store any requests, resources, information, data, signals, or similar that are described herein. The network function 1800 may be configured operate in the manner described herein in respect of an network function.

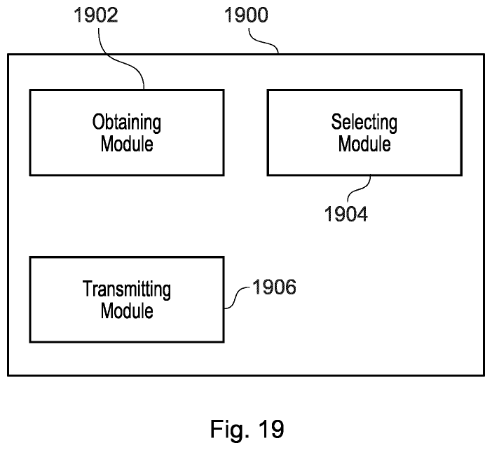

FIG. 19 is a block diagram illustrating a first network function 1900 according to some embodiments. The first network function 1900 comprises an obtaining module 1902 configured to obtain, at an initial time to, a prediction of a performance degradation associated with at least one performance metric at a first time, t₀+T, in the future. The first network function 1900 comprises a selecting module 1904 configured to responsive to obtaining the prediction, at each current time, t, from t₀ to t₀+T: select a first set of network functions, NFs, fᵢ, wherein each network function in the first set is associated with a delay time, d(x_{i,t}) for the NF to impact the network, wherein for each of the first set of NFs a first condition of d(x_{i,t})<t₀+T−t is met. The first network function 1900 further comprises a transmitting module 1906 configured to transmit an indication of the prediction to the first set of NFs. The first network function 1900 may operate in the manner described herein in respect of a first network function, an analytics network function or an NWDAF.

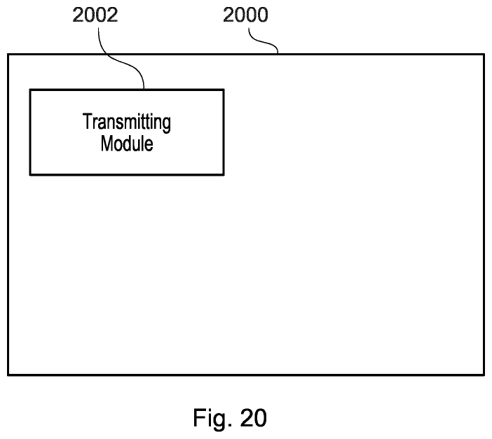

FIG. 20 is a block diagram illustrating a second network function 2000 according to some embodiments. The second network function 2000 comprises a transmitting module 2002 configured to transmit, to an analytics network function, an indication that the second network function will accept being notified proactively with an analytic report. The second network function 2000 may operate in the manner described herein in respect of a second network function.

There is also provided a computer program comprising instructions which, when executed by processing circuitry (such as the processing circuitry 1801 of the network function 1800 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

By having the NWDAF be able to proactively contact relevant NFs to address a predicted performance degradation in the network at the time when it is discovered allows the system to solve the problem faster than if each NF could only be contacted based on regular intervals or events pre-specified by the NFs. The embodiment described herein thus reduce the ensuing performance degradations.

As a consequence, embodiments described herein also reduce the need to have the NFs' transmit requests for information as frequently, as information exchange will partly be triggered only, when necessary, thus reducing excess information exchange and periodic computations at the NWDAF.

Embodiments described herein also allow the NWDAF to select an efficient subset of the potentially relevant NFs in order to address the predicted performance degradation rather than having every NF which could have a timely impact on the problem act on its own.

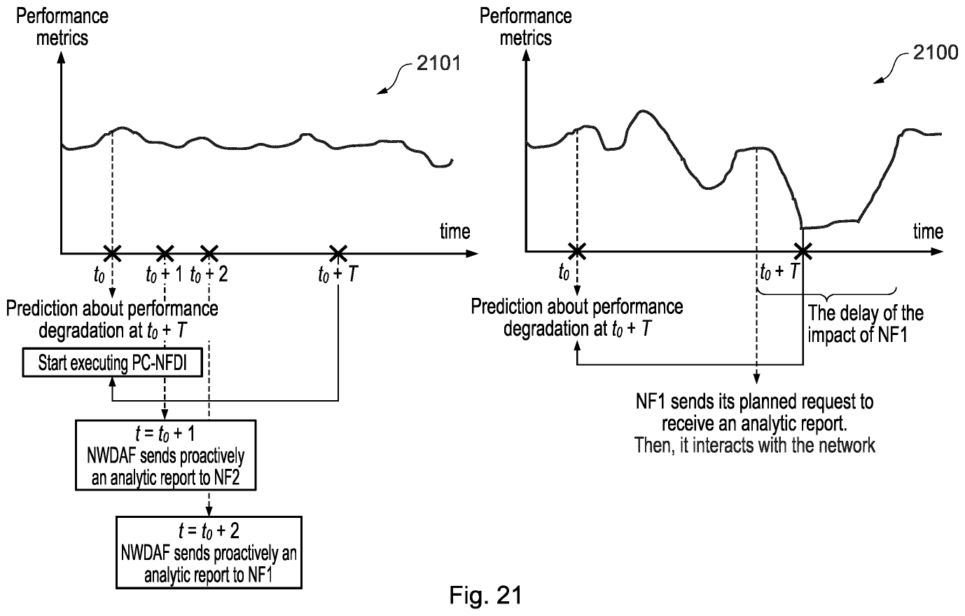

FIG. 21 illustrates how the embodiments described herein may be used to avoid the degradation of the performance metrics. The graph 2100 depicts the performance metric variation when embodiments described herein are not used. As shown in this graph 2100, the NWDAF predicts a future degradation in the performance metrics. However, none of the relevant NFs that could act to avoid this prediction are involved in signalling with the NWDAF during this period. NF1 is requesting its periodic default analytic report but it is incapable of improving this predicted performance degradation because of its long delay of impact.

However, graph 2101 illustrates the performance metric variation when embodiments described herein are used. Here it can be seen that the embodiments described herein allow the NWDAF to proactively contact NF1 and NF2, i.e., the relevant NFs, and therefore the predicted performance degradation is avoided.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method in a first network function, NF, for improving a performance of a network, the method comprising:
obtaining, at an initial time to, a prediction of a performance degradation associated with at least one performance metric at a first time, t₀+T, in the future; and
responsive to obtaining the prediction, at each current time, t, from t₀ to t₀+T:
selecting a first set of network functions, NFs, fᵢ, each network function in the first set being associated with a delay time, d(x_{i,t}) for the NF to impact the network, for each of the first set of NFs a first condition of d(x_{i,t})<t₀+T−t being met; and
transmitting an indication of the prediction to the first set of NFs.

2. The method as claimed in claim 1, wherein the selecting is performed using time-series forecasting.

3. The method as claimed in claim 2, wherein the selecting comprises training a ML model to perform the time-series forecasting.

4. The method as claimed in claim 3, wherein the ML model comprises a reinforcement learning model.

5. The method as claimed in claim 4, wherein the selecting comprises:
inputting, into the ML model, a plurality of previous states, sₜₘᵢₙ to sₜ, and previous sets of NFs, aₜₘᵢₙ to aₜ₋₁, that have already received an indication of the prediction between a minimum time, tₘᵢₙ and a previous time, t−1, wherein each state sₜ comprises values of the at least one performance metric at a time t;
for each of a plurality of candidate first sets of NFs, at, outputting a prediction of a plurality of future states, s′ₜ to s′ₜ₊ₕ, from the current time t to a second time t+h, where t+h≤t₀+T; and
selecting the first set of NFs, aₜ, that will receive analytic reports at t, as to increase a reward function that is derived from the plurality of future states using a first policy.

6. The method as claimed in claim 5, wherein the reward function comprises a cumulative expected reward between the minimum time, tₘᵢₙ and the second time t+h that is representative of an improvement in the at least one performance metric.

7. The method as claimed in claim 5, wherein the minimum time, tₘᵢₙ is equal to the initial time, t₀.

8. The method as claimed in claim 5 further comprising:
at the initial time to, setting tₘᵢₙ=t₀;
responsive to, at the current time t, the first set of NFs comprising an NF that provides an impact at a later point in time than any other NF selected in the times tₘᵢₙ to t−1, resetting tₘᵢₙ=t.

9. The method as claimed in claim 5, further comprising:
responsive to transmitting the indication of the prediction to the set of NFs, receiving an actual reward; and updating the first policy based on the actual reward

10. The method as claimed in claim 1, from the first set of network functions, subscription requests subscribing to receive analytics information proactively from the first NF.

11. The method as claimed in claim 1, wherein the first NF comprises a Network Data Analytics Function, NWDAF.

12. A method in a second network function for avoiding a degradation in performance of one or more performance metrics in a network, the method comprising:
transmitting, to an analytics network function, an indication that the second network function will accept being notified proactively with an analytic report.

13. A first network function for improving a performance of a network, the first network function comprising processing circuitry configured to cause the first network function to:
obtain, at an initial time to, a prediction of a performance degradation associated with at least one performance metric at a first time, t₀+T, in the future; and
responsive to obtaining the prediction, at each current time, t, from t₀ to t₀+T:
select a first set of network functions, NFs, fᵢ, each network function in the first set being associated with a delay time, d(x_{i,t}) for the NF to impact the network, for each of the first set of NFs a first condition of d(x_{i,t})<t₀+T−t being met; and
transmit an indication of the prediction to the first set of NFs.

14. The first network function as claimed in claim 13, wherein the selecting is performed using time-series forecasting.

15. A second network function for avoiding a degradation in performance of one or more performance metrics in a network, the second network function comprising processing circuitry configured to cause the second network function to:
transmit, to an analytics network function, an indication that the second network function will accept being notified proactively with an analytic report.

16. A computer storage medium storing a computer program comprising instructions which, when executed on at least one processor, cause the at least one processor to carry out a method, the method comprising:
obtaining, at an initial time t₀, a prediction of a performance degradation associated with at least one performance metric at a first time, t₀+T, in the future; and
responsive to obtaining the prediction, at each current time, t, from t₀ to t₀+T:
selecting a first set of network functions, NFs, fᵢ, each network function in the first set being associated with a delay time, d(x_{i,t}) for the NF to impact the network, for each of the first set of NFs a first condition of d(x_{i,t})<t₀+T−t being met; and
transmitting an indication of the prediction to the first set of NFs.

17. (canceled)

18. The first network function as claimed in claim 14, wherein the selecting comprises training a ML model to perform the time-series forecasting.

19. The first network function as claimed in claim 18, wherein the ML model comprises a reinforcement learning model.

20. The first network function as claimed in claim 19, wherein the selecting comprises:
inputting, into the ML model, a plurality of previous states, sₜₘᵢₙ to sₜ, and previous sets of NFs, aₜₘᵢₙ to aₜ₋₁, that have already received an indication of the prediction between a minimum time, tₘᵢₙ and a previous time, t−1, wherein each state sₜ comprises values of the at least one performance metric at a time t;
for each of a plurality of candidate first sets of NFs, at, outputting a prediction of a plurality of future states, s′ₜ to s′ₜ₊ₕ, from the current time t to a second time t+h, where t+h≤t₀+T; and
selecting the first set of NFs, aₜ, that will receive analytic reports at t, as to increase a reward function that is derived from the plurality of future states using a first policy.

21. The first network function as claimed in claim 20, wherein the reward function comprises a cumulative expected reward between the minimum time, tₘᵢₙ and the second time t+h that is representative of an improvement in the at least one performance metric.
